(19) United States
(12) Patent Application Publication
(10) Pub. No.: US 2016/0179573 A1
(43) Pub. Date: Jun. 23, 2016

(54) METHOD FOR PROVIDING MAINFRAME STYLE BATCH JOB PROCESSING ON A MODERN COMPUTER SYSTEM

(71) Applicant: Bull HN Information Systems Inc.

(72) Inventors: TODD BRADLEY KNEISEL, Phoenix, AZ (US); Russell W. Guenthner, Glendale, AZ (US); Brian William Lemke, Cave Creek, AZ (US)

(21) Appl. No.: 14/579,869

(22) Filed: Dec. 22, 2014

(51) Int. Cl. G06F 9/48; G06F 9/54

(52) U.S. Cl. CPC G06F 9/4881; G06F 9/542

(57) ABSTRACT

A method is disclosed for controlling a computing apparatus in the execution of a plurality of programs in an ordered fashion, the execution performed in a manner that emulates the processing of batch jobs described with a job control language on a mainframe computer system, the method utilizing a standardized user directory and file structure in providing a batch execution environment.

### CROSS REFERENCE TO RELATED APPLICATIONS

### STATEMENT REGARDING FEDERALLY SPONSORED RESEARCH OR DEVELOPMENT

NONE

### THE NAMES OF PARTIES TO A JOINT RESEARCH AGREEMENT

NONE

### INCORPORATION BY REFERENCE OF MATERIAL SUBMITTED ON A COMPACT DISC

NONE

### BACKGROUND OF THE INVENTION

Mainframe computer systems typically provide for processing a series of commands with a system approach commonly known as “batch” processing. Batch files contain a series of commands or tasks that are processed together as a “batch”. The term “batch” stems from the early days of computing when punched cards were used to control processing by a computer system and were loaded into a card reader as a “batch” of cards.

Batch processing is typically performed by a batch “job” and the commands which tell the computer system what to do are contained in file (or files) and described in a language called a “job control language” (JCL). A JCL file describes a batch job to a computer system by providing the information necessary to perform a task or a series of tasks. A JCL often specifies a sequence of tasks, with information passed from one task to the next. A series of tasks is often described as a series of “activities”. A JCL file typically describes tasks as a series of “activities”, with each in the series of activities performing a task, and with provision to pass information from one activity (task) to a following activity. The JCL file typically describes how data and other information flows from one activity or task to the next, and also may describe non-sequential control flow which may skip or modify an activity depending on results from previously processed activities.

Batch processing and a hatch job control language have typically been provided on large mainframe processing systems. The basic forms of JCL statements have not changed much since they were first introduced in the mid-1960s. One reason for this is that once these languages were in heavy use it was difficult to change the languages because many, many programmers depended on them doing exactly what they had always done.

Some mainframe computer systems also provide for processing with a system approach commonly called “time sharing”. Time sharing lets a user interact more directly with a computer system than with a batch job, typically providing for a user to type commands and tell the computer system what to do in an interactive manner. In a time sharing system multiple users typically interact with a computer system at the same time. In a batch system, there is typically no user interaction between activities of a batch job. Batch processing may typically be performed by “background” jobs, and time sharing commands are processed in the “foreground” at a higher priority. In some modern computer systems “batch” and “time sharing” services are tightly integrated.

It is noted that time sharing systems are often themselves a “batch” job.

In migration of computer programs and processing from large mainframe computer systems to typical modern day systems the concept of providing for a batch processing approach has not typically been made available on systems such as “Linux” ® and “Windows”™.

“Linux” is a UNIX™ like operating system developed by Linus Torvalds, after whom it is named. “Windows” is an operating system developed by Microsoft Corporation. Both Linux and Windows exist in several forms and/or versions with various releases and updates. Linux® is a registered trademark of Linus Torvalds in the U.S. and other countries. “Windows”® is a registered trademark of Microsoft Corporation in the United States and other countries. Windows is a trademark that identifies Microsoft operating system software. The Open Group is the owner of the UNIX trademark which it holds on behalf of the industry.

Within both Linux and Windows there are scripting languages (such as BASH) which provide for control of a series of tasks, but the formality and organization of typical mainframe Job Control Languages and support for processing a JCL file have not been included in the operating systems of many modern computer systems.

This lack of support for mainframe Job Control Files and Job Control Languages has slowed the migration of mainframe programs and computer data systems to “open” systems such as Linux. One reason for this is that systems such as Linux have not included some of the concepts typical of mainframes. Examples of this include the concept of files being specified by “file codes”. Open systems have also not typically provided batch control scripting languages that support the concept of “activities”. Open systems have also not provided for the passing of file code references in an organized form from one activity to another or to multiple following activities. Open systems have also not typically provided for the utilization and easy management of temporary files, that is files that are passed from one activity to another and discarded after their usefulness is over.

It would therefore be an improvement if concepts of batch processing from a mainframe are extended in a form suitable for performing processing in the manner of “batch” on modern open (Linux) systems.

### BRIEF SUMMARY OF THE INVENTION

Typical “modern” or “open” operating such as Linux or Microsoft Windows do not typically provide for batch processing in a manner analogous to that typically performed on older “mainframes” with older operating systems. Linux and Windows do provide for scripting or “.bat” files, but these scripting programs do not provide for the structure of a more formal job control language typical of prior mainframes, nor for the launching and monitoring facilities that go along with the JCL and batch processing. It is also not easy to migrate or translate a batch program described in a job control language to scripts such as “BASH” or other more modern scripting languages. Scripting languages such as BASH do not provide many of the features provided by a general job control language such as provision for description of “activities”, general handling and description of “file codes”, conditional branching from one activity to another, and other such features. In fact, the lack of features makes for not only a difficult translation, but also in actual use such a translated file is or would not be easily maintained or understood by a user such as a computer operator or programmer.

In particular, the concept of file codes is somewhat foreign to both the Linux and the Windows operating systems. Therefore in providing for a batch facility on Linux or Windows a clear and precise method of handling files described and referenced by “file codes” is necessary. A “file code” being a short form reference to a file described with a filename. For example a file code of “F1” can be assigned to a file named “/home/user/FileForProcessing”, and throughout a JCL file the filecode “F1” can be used to reference a file described elsewhere in the JCL file with a “card” that describes where “F1” is located. It is noted that filecodes are also used to pass information from one activity to another in a typical JCL file. That is, that a file code persists in its reference between activities of a batch job. It is further noted that the assignment of file codes can also be changed from one activity to the next by specifying a new file code assignment or relationship.

A second provision in batch processing not provided in typical scripting languages on operating systems such as Linux or Windows is the concept of “activities” with a batch job. An “activity” is typically an invocation of a “program” with input and output, or it can also be a sequence of programs with specified input and output. “Activities” are strung together in a batch job to perform a sequence of tasks, and the invocation of an activity can depend on the results of previous activities, or even on conditions set by external events or conditions.

A third provision in batch processing not provided in typical scripting languages on operating systems such as Linux or Windows is provision for branching and generalized condition testing for controlling the processing of activities in a batch job. In particular, the common BASH scripting language does not provide for “GOTO” type transfer of control processing, which makes the translation of a JCL file to a “BASH” script more difficult. BASH does provide compound constructs for control of looping and conditional constructs but these do not provide for flow control in the manner necessary for the processing of typical JCL type files.

Providing for a batch execution environment on a modern operating system such as Linux that does not provide operating system features that directly support batch processing requires utilization of operating system features that do exist in a manner such that a desired batch execution environment can be implemented. Providing, as a feature of the present invention, for utilization of a file/directory structure designed and structured specifically to emulate a batch processing methodology from a mainframe and operating and within a user's environment and including the use of linking files (links) within that file/directory structure to reference files in locations outside provides a unique approach on Linux and other modern operating systems such as AIX which has significant advantages over the prior art approach of utilizing standard scripting programs such as Bash and Peri.

In a first embodiment incorporating at least one aspect of the present invention the relationship between file codes is managed by utilizing a special arrangement of file system links to organize and persist relationships between one or more file codes and their respective actual file names. The file codes, which are typically two characters in length but this is not restrictive, are related to their respective file names by file system “links” which provide a map for locating a file given its file code. The file code “links” are placed in an execution directory which is a specific file system directory in which a specified program activity is executed. In more detail a single execution directory is specified which is a directory from which a program (or programs) related an activity is launched. This directory is often called the “current” directory. Programs that run from the current directory are provided direct access to files “in” that directory, and by placing links in that current directory to actual file names, file codes are mapped from that current directory to desired actual file locations.

As second optional feature of an embodiment of the present invention, these same links between file codes and actual files are used to map the same file relations described for a first activity during execution of programs in a second or following activity. This is accomplished by either launching the second activity's programs in the same current directory as utilized for the first activity, or by creating equivalent links in a second directory, the second directory used as the current directory for programs in the second activity or processing.

A third optional feature of an embodiment of the present invention is provided with a job execution control program that provides for branching of control within a provided job control file. One example of such a control provides for processing of a “GOTO” command which transfers control in the JCL to a specified “label” within that jcl file, or to another jcl file. Transfer of control is not limited to just “goto” processing; control commands are also optionally provided for looping and testing of conditions, and for special branching such as branching to the end of job, or branching to a standardized activity or specific processing such as an organized method of handling errors.

As an illustration, a job is executed within a standardized directory structure that is used to manage the flow of data and files between a series of activities within a single batch job, and also for the purpose of capturing and monitoring all information related to a job. All information related to a specific batch job is stored within this directory structure. A directory is created or previously specified for each batch job and may optionally be given a meaningful name such as, for example, the job “number”.

Activity directories are then created beneath a specific job directory. The activity directories can optionally be named with a convention for naming, for example, something like “Activity-1”, “Activity-2” etc. Alternatively the JCL (or JCL file) can itself specify names of activities which may provide for better monitoring and understanding of output reports. Other alternative naming conventions or methods could be developed by one knowledgeable in the art of computer system batch processing.

Further optional features in embodiment of the present invention are provided in a similar manner to provide necessary aspects of communication between activities of a batch job utilizing a concept of storing communication information in files of the computer system with those files located in the current execution directory of the program (or programs) being executed within a batch activity. A common example from the COBOL language which is commonly used in performing batch programs is the program switch word. A “switch” word or “switches” are bits or words that a first program can set or reset, and these bits or words can then be read and/or written by a second program, the second program typically being in another activity of a batch job. “Switches” may also be used for communication between a program and the operating system. Switch words or “switches” are not typically provided on a Linux or Windows system in a manner identical to that of a typical older “mainframe”. Emulation of the functionality of switches is provided in one optional feature in an embodiment of the present invention by representing or storing the switches or switch words in a file or files stored within the current activity directory of an executing program. The switch words can then be located and read or modified by the operating system or other programs in a second activity by simply referencing the known current directory and reading or writing files with a special name defined by convention.

All information of this type stored in files in the activity directory can be passed from one activity to a second or subsequent activity by copying such files to the second activity directory or by starting execution of the second activity in the same directory as the first activity. It is preferable to utilize a separate directory for each activity in order to provide for statistics and information about each activity after a job comprising several activities has completed, and this is the preferred embodiment of this aspect of the present invention.

In a similar manner statistics and other information can be collected and stored in the current directory utilized by each activity, with information stored in files named by convention, and then statistics and reports from an entire job are collected by examining the contents of all activity directories stored and related to a specific job.

It is noted that this optional aspect of a preferred embodiment of the invention which stores in an organized and standardized manner all information relating to a batch job and all activities that comprise the batch job provides distinct advantages over approaches of the prior art. In previous mainframe systems the control structures such as these were stored in tables internal to the operating system which were not available directly to the user. This required that the operating system be made aware and that the operating system itself must manage and handle all information necessary to process the job and to provide means for accessing that information to any other tools or programs that required such information. This includes such information as the relationships between files and file codes, job status, activity start time, activity end time, location of sysout reports and many other things. In manner of this aspect of the present invention such information is stored in a standardized directory and file structure that is visible to the normal system user. This allows for programs to communicate between activities with involvement by the operating system only in the normal manner of processing a program. No handling is required by the operating system that is special because the job is a batch job. That is, the approach of the present invention provides for batch processing on a Linux system, for example, without requiring any changes or enhancements to the Linux operating system specifically for the batch processing. This approach allows for batch processing to be performed at a user level, and also allows for monitoring and control to be done at any level. That is, users can make batch jobs visible to other users, or each user can maintain their own batch control structure. On large systems a common batch control directory can be set up as the top level directory for all batch jobs, and normal Linux file system permissions can be used to make certain jobs visible or controllable by specific users or by all users.

In general what is provided in one embodiment of the present invention is a Linux based facility providing batch processing utilizing the standard facilities available to a user of Linux (not a “system” or operating system job). The features include: a) “Mainframe” Job Flow Control and Monitoring, b) a Job Control Languag, c) provision for describing a sequence of “Activities” as a single “Job, d) provision for connecting files between Activities (as file codes), e) “Flow Control” within a JCL file for handling of IF conditions and exception conditions, f) monitoring of jobs from external programs utilizing the standardized file structure of the batch job for gathering statistics (without tracking by the Linux OS), g) support for scanning of all activities of a job both during and after execution of a job, and h) provision for examining and archiving results of an entire job after the job is complete.

### BRIEF DESCRIPTION OF THE SEVERAL VIEWS OF THE DRAWINGS

The subject matter of the present invention is particularly pointed out and distinctly claimed in the concluding portion of the specification. The invention, however, both as to organization and method of operation, may better be understood by reference to the following description taken in conjunction with the subjoined claims and the accompanying drawing in which:

FIG. 1 provides illustration of the general flow of a batch job on a Linux system in the manner of at least one aspect of the present invention;

FIG. 2 illustrates an exemplary BATCH directory structure on a Linux system for controlling, monitoring, and the general handling of BATCH jobs on a Linux system in user accessible file and directory space in the manner of at least one aspect of the present invention;

FIG. 3a and FIG. 3b provide exemplary job execution reports for a job throughout its life of execution with FIG. 3a illustrating launching of a job, executing a job, and job in termination, and FIG. 3b illustrating output available after completion of execution of a job;

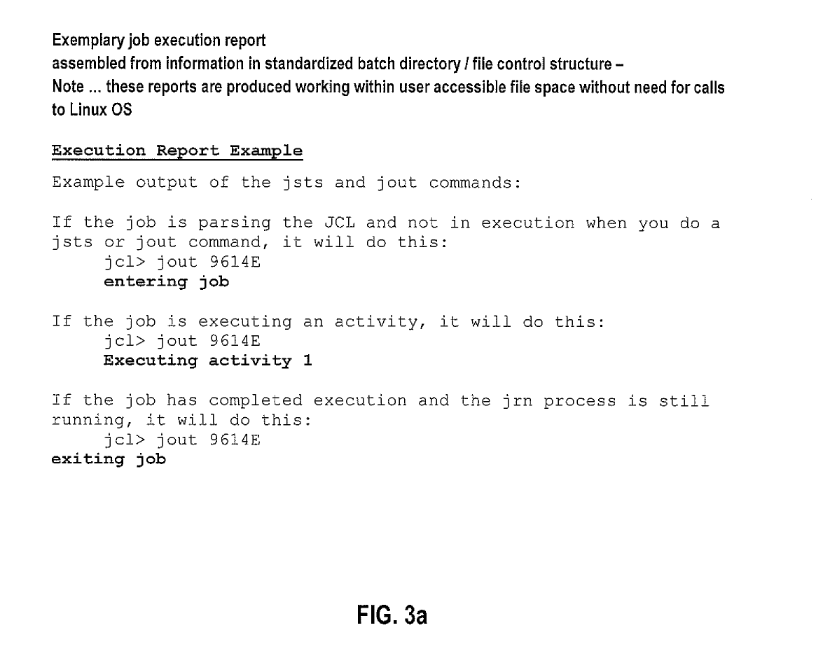

FIG. 4 illustrating the “activity_n” directory in which a job is run;

FIG. 5 illustrating a directory “station_xx” for capturing output directed to specific “print” stations during execution of a job;

FIG. 6 illustrating a directory containing data files relevant to execution of a job in a specific activity;

FIG. 7 illustrating symbolic links within a directory for files passed from one activity to another called a “luds” directory; and,

FIGS. 8a and 8b provide illustration of exemplary batch job control language (JCL) with FIG. 8a illustrating exemplary JCL and FIG. 8b illustrating exemplary output from running the exemplary JCL file from FIG. 8a.

### DETAILED DESCRIPTION OF THE INVENTION

The above is an overview of several illustrated embodiments implementing the machine method of the present invention and provides exemplary examples utilizing selected aspects described in connection with certain embodiments of the present invention.

Features of the present invention in one embodiment are provided by creation of execution environment (typically on an “open” system such as Linux) in which a batch job is run in a user execution environment (instead of by or within the operating system environment of prior art mainframe systems).

A description of a user execution environment that provides exemplary features of the present invention now follows. A Batch Executive runs jobs within a pre-defined directory. This directory is optionally defined by an environment variable or a configuration file. When a batch job is executed, a directory for the SNUMB (job identification number or name) is created under the batch root directory. In a preferred implementation, the directory name is the SNUMB number. For example, a job name of SNUMB “9614E” is assigned.

As the batch job executes each activity, a directory is created for each activity under the SNUMB directory. The directory is named “activity_N” where “N” is the activity number. When an activity is executed, the current directory in which the program or script of that activity will be launched (started) in this activity directory. The concept of filecodes in mainframe batch jcl are implemented on Linux as symbolic links to a file. The symbolic links are created in the activity directory. Programs executed in an activity can open, read, and write a filecode in the current directory and the I/O will be performed on the target of the symbolic link. A filecode that is not saved between activities is a symbolic link directly to the target file. These filecodes are created by exemplary control cards such as “_data” and “_sysout” statements, and by_prmfl and_file statements without LUDs. Filecodes created by a statement with a LUD are a symbolic link to another symbolic link in the directory named “luds” under the SNUMB directory. The symbolic link in the “luds” directory is a link to the actual file.

When an activity terminates and a LUD has “SAVE” disposition, the filecode is deleted but the LUD symbolic link is not deleted. The next activity that references the LUD can then link to the existing LUD symbolic link. When an activity terminates and a LUD had “RELEASE” disposition, the filecode and LUD symbolic links are deleted.

If an activity does not define a “P*” (standard output file) filecode, the Batch Executive generates one automatically. This default “P*” is a symbolic link to a file in a sysout directory under the SNUMB directory. The default sysout directory is named “station_ORG”. There is a subdirectory under this directory for each activity, named “activity_N” with “N” replaced by the activity number. The physical file in this directory will be named “P*”.

A_sysout statement without a destination, or with the—ORG option will create a file in the “station_ORG” sysout directory, similar to the default “P*” filecode. A_sysout statement with a destination creates a new sysout directory named “station_{—} DD” where “DD” is replaced by the destination name. There are directories under this directory for each activity that assigns a filecode to this station.

When a batch job is executed, the Batch Executive creates a file in the SNUMB directory that contains the Program Switch Word (PSW) used by COBOL programs and the “_if'statement. This file, named “ProgramSwitchWord”, contains 36 characters representing the state of each switch in a COBOL PSW. A ‘0’ (zero) character indicates that a switch is off Any other character indicates that the switch is on. When an activity executes, a symbolic link with the name “switches” is created in the activity's current directory. This symbolic link is attached to the PSW file in the SNUMB directory. The program executed in the activity can then read and write the “switches” file in the current directory to set and unset switch values. The COBOL Compiler will generate code that accesses this file.

When a batch job executes, the Batch Executive saves the job start time in a file named “StartTime” under the SNUMB directory, and the job end time in a file name “EndTime” under the same directory.

An_ident statement in the JCL will create a file named “Ident” in the SNUMB directory. The content of this file is the string argument of the_ident statement.

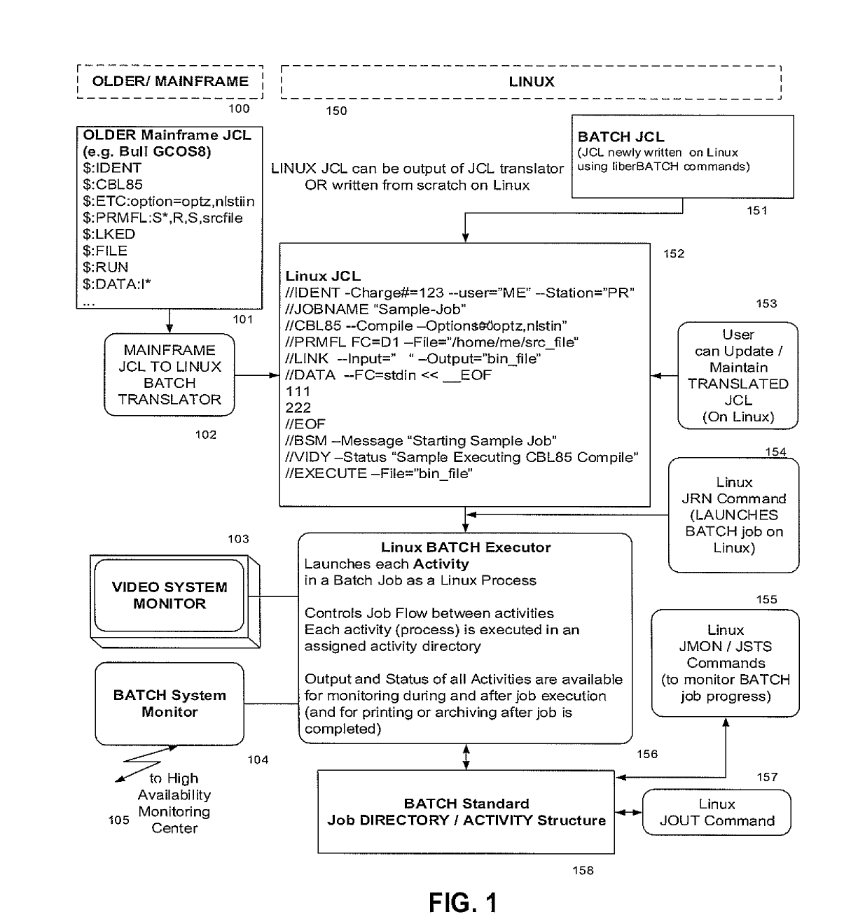

FIG. 1 provides illustration utilizing aspects of the present invention in an exemplary embodiment of an implementation of a method for processing batch jobs 151 on a Linux system 150 at a user level in the manner of batch programs 101 processed on older mainframes 100, the older mainframe batch process enable by direct support from the operating system at a system level rather than at a user level. The illustrated method provides for translation of older mainframe batch job control files 102 to similar job control files 152 on Linux 150. A user on Linux can update 153 or create Linux batch JCL files 152 for processing on the Linux system. Linux JCL files are processed by a Batch Executor 156 which in a preferred embodiment is a supervisory program running at a user level on Linux, the Batch Executor program initiated by a user and running with that user's permissions. It is typically not necessary for the Batch Executor program 156 to be run as a Linux superuser. In one preferred embodiment the Batch Executor is provided as a Java program launched 154 by a normal user (not a superuser). The Batch Executor program creates a directory structure at a location in the Linux file system to which he has at least read, write, and create permissions. Utilization of a standard location and organization 158 that is created and maintained within the user's accessible file/directory space is a key feature of the present invention in certain embodiments. Utilization of a standardized/agreed upon file and directory structure allows other user jobs to be provided such as monitoring commands 155 for monitoring a batch job while it runs, and output examination commands 157 for examining results of a batch job after it has been completed. This same standardized structure also allows for monitoring and optionally control of batch jobs to be done in a manner desirable for system operators or system monitors 103 and 104. It also provides for standardized monitoring by an off-site or supervisory monitoring service 105 such as a high availability support center.

The standardized user directory/file system for running and monitoring jobs provides advantages over prior art scripting systems for running a series of jobs such as those typically provided by Linux bash scripts. The organization and the use of links within the standardized structure to point to and connect to files outside of the structure are key features in preferred embodiments of the present invention. Haphazard scripting by different users to provide for running a series of “activities” or programs as typical of the prior art on systems such as Linux does not provide for organized monitoring or control and does not provide for an easily understood Job Control Language style flow that was typically available only on mainframe systems. Providing this style and level of control and monitoring while allowing for jobs to be run by users and without operating system or superuser access is one advantage in certain embodiments of the present invention.

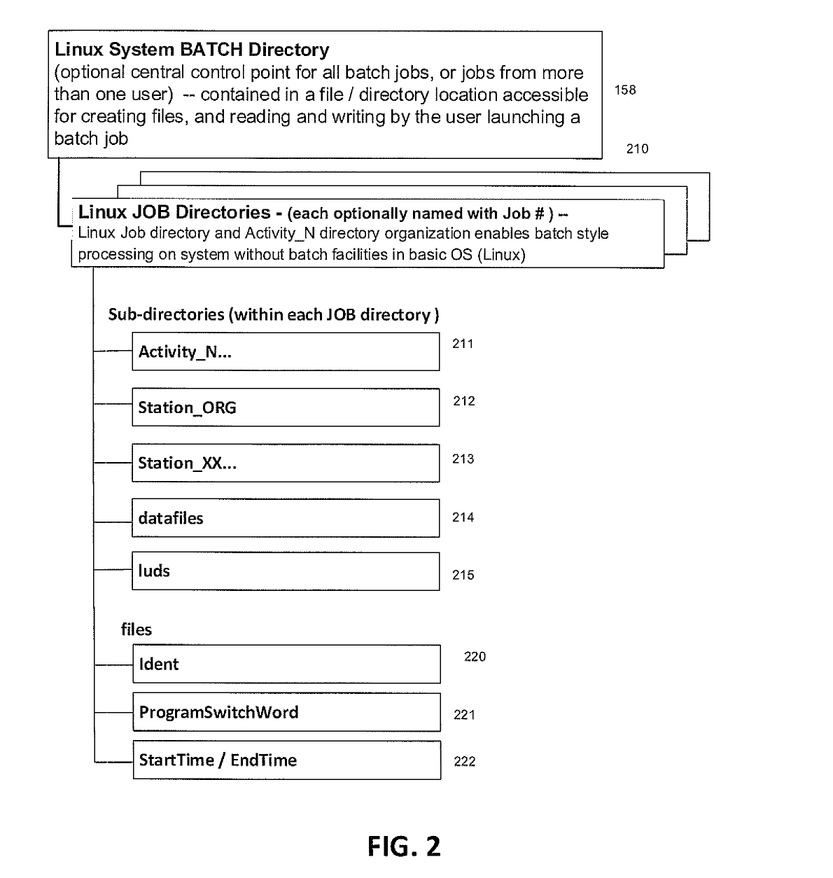

FIG. 2 provides illustration of a standardized directory/file structure created within a user's accessible space which is a key implementation feature of the present invention providing for standardized control and monitoring system by a collection of user level programs (typically written in java) working in coordination to provide a batch type facility on Linux (or other “open” systems which do not provide “batch” at an operating system level). Utilizing a system wide batch directory 158 (described optionally utilizing a user's environment variable, and optionally in a directory structure also accessible to other users) provides a common location for running all system jobs, all group jobs, or all of a specific user's jobs. Links can be created in a system wide batch directory to point to a user's batch directory, with this approach possibly requiring a program with root or higher level user permissions to write into a higher level directory not accessible for general file creation, reading and writing (in order to provide security). An optional system wide batch directory 158 which can alternatively be a batch directory only for one or a group of users contains within it (or points to) “job directories” 210 which are directories created for the execution of a batch job, one job directory for each batch job. (A batch job comprising one or more “activities” or programs). A run command typed by a user such as “jrn” (for “job run”) launches a job described in a “jcl” (job control language) file. Each activity of a job causes creation of an activity directory 211 in which the program making up the activity is then run. That is, the launch point, or start directory, or reference point of the program is within this activity_n directory and references to files from previous activities or to future activities are made by referencing either links or files themselves from the location of the activity directory. In this illustrated embodiment other directories within the job directory provide storage and pointers to other necessary information for batch processing such as “station_org” 212, “station_xx” 213, datafiles directory 214, “luds” 215, also accounting and tracking files such as “ident” file 220, “program switch word file” 221, and start/end time recording files 222.

Activity_N directories 211 are created for each activity in a job where in this example “N” is the activity number. The station_ORG directory 212 is the default SYSOUT directory which is where stdin, stderr, and stdout files are directed (stored). A station_XX directory213 is created for each station defined by a SYSOUT card which is used for printing output from a specific activity. A datafiles directory 214 contains temporary files created by the_data and_file statements (files without any file I directory location except during the processing of the batch job). A “luds” directory 215 contains files or links saved between activities. This is a key feature of the present invention providing for a standardized methodology for passing files between activities of a batch job, and providing for this feature utilizing standard “links” which in the prior art on a mainframe was provided in a different manner by the operating system itself outside of the user environment. An Ident file 220 stores banner information from a job identification statement for use by monitoring and video display programs, and also for providing user description of a job.

A ProgramSwitchWord file 221 contains values of the switch word or switch bits as typically passed by COBOL programs from one activity to the next in a batch job. In the prior art these bits are typically maintained in memory by the operating system. In this illustrated embodiment of the present invention the data of the switch word is stored in a user file within the standardized batch job directory structure such that it the data of the switch word bits can be maintained and passed from activity to activity within the batch job. StartTime and EndTime files 221 contain the job starting and ending times, typically used for accounting purposes, in the prior art typically maintained by the operating system rather than by a user job itself.

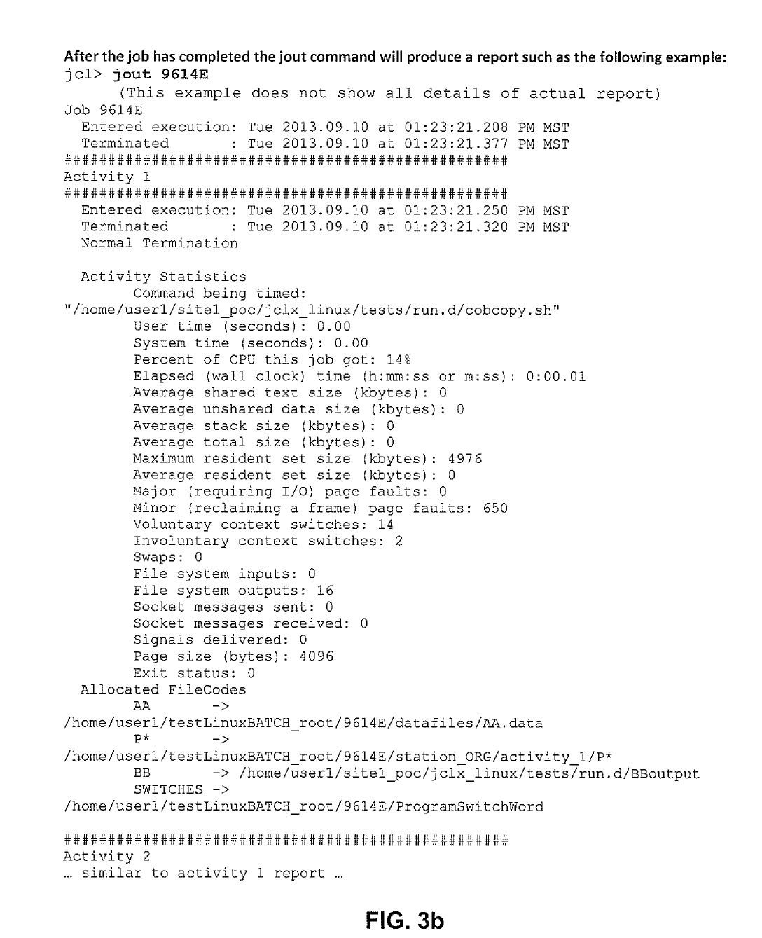

FIG. 4 provides further illustration of an “activity” directory. “Files” in the exemplary activity_N directory 400 are not actually files but are instead symbolic links to actual files (or further links) in other locations. The names of the “filecode” links 410 are typically the “file codes” in the manner of mainframe batch jcl (typically two characters). Filecodes are created by control cards such as the_prmfl, _data, _file, or _sysout statements. The “P*” filecode 420 is created automatically, or by, for example, a_prmfl or_sysout statement and is a link to a file in the station_ORG sysout directory. The “switches” link 430 points to the ProgramSwitchWord file in the SNUMB directory. When an activity is executed, the activity_N directory will be the process current directory. The process can access filecode links and the switches file in the current directory. Linux stdout and stderr files are directed to the P* filecode which is also a link. The “link” files provide a link from a “file code” to an actual file with a filename and are contained within the activity_N directory which is where a job is executed. This allows for files to be in any place on the system and to still be locatable while a job is being run utilizing the links. This key feature of the present invention provides for file codes to be handled on a Linux system in a manner similar to batch processing on a mainframe where the file code concept is provided as part of the mainframe batch operating system.

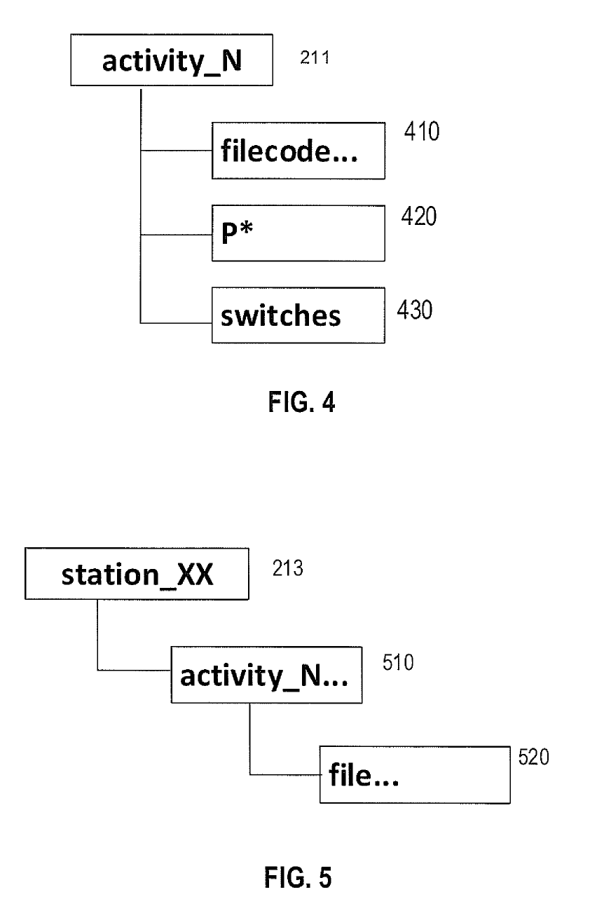

With reference to FIG. 5, station directories 213 contain the sysout of each station defined by the job. For standardization, “XX” is replaced by the station name. “Station_ORG” is the default sysout directory. Jobs can create multiple sysout directories with the_sysout statement. Within each sysout directory, an activity_N directory 510 is created for each activity that directs output to the station. Within the activity directory, a file 520 is created for each filecode that is directed to the station. When an activity is executed in the SNUMB/activity_N directory and a filecode is assigned to sysout, the filecode is a symbolic link to the file in the station_XX/activity_N directory.

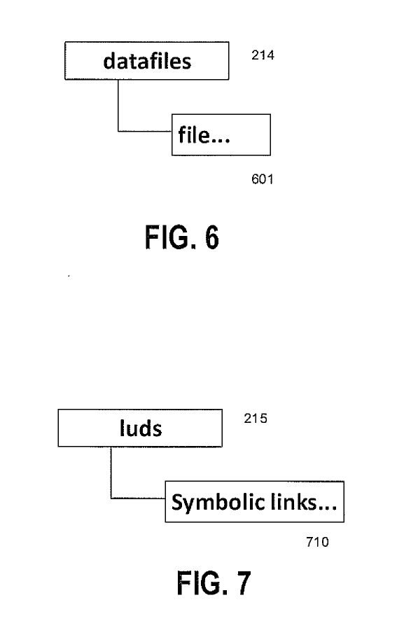

With reference to FIG. 6, files 601 in a “datafiles” directory 214 are created by_data or_file statements. When an activity is executed in the SNUMB/activity_N directory and a_data or_file statement creates a file, the filecode is a symbolic link to the file in the datafiles directory. Filenames are created with the specified two character filecode and with file name extension of “.data”.

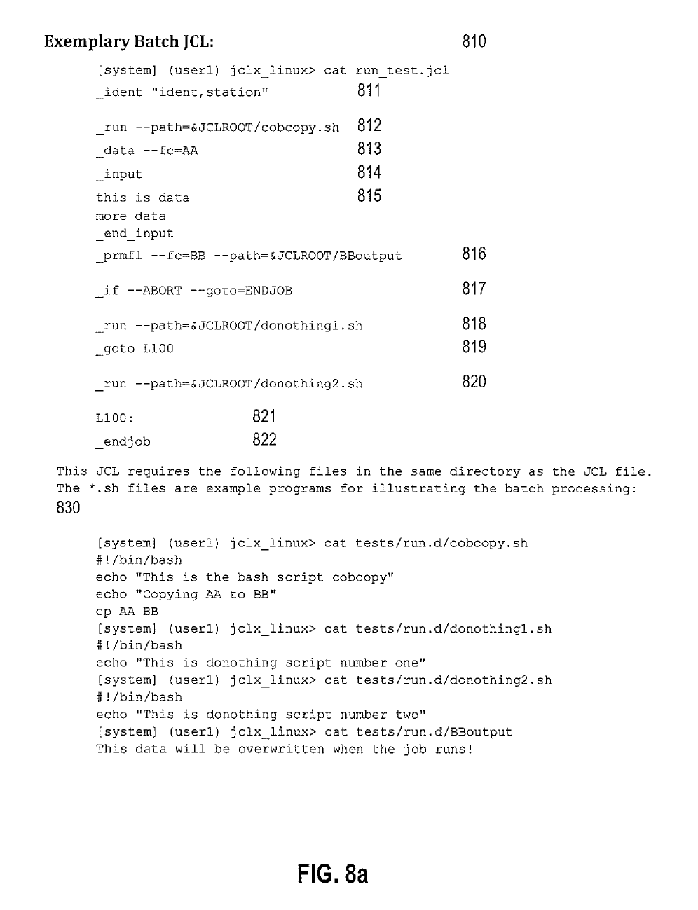

With reference to FIG. 7, a “luds” directory 215 is used to save allocated files across activities. When an activity creates a filecode with a _prmfl or_file statement using the—lud option, in addition to creating the filecode symbolic link in the activity directory, a symbolic link 710 is created in the luds directory. The symbolic link in the luds directory references the same target file as the filecode symbolic link in the activity directory. A lud defined with the “S” (Save) disposition is retained when the activity terminates. A lud defined with the “R” (Release) disposition is released when the activity terminates. A_file statement referencing a lud from a previous activity will locate the lud in the luds directory, then create a filecode symbolic link in the activity directory, referencing the same target file as the lud symbolic link.

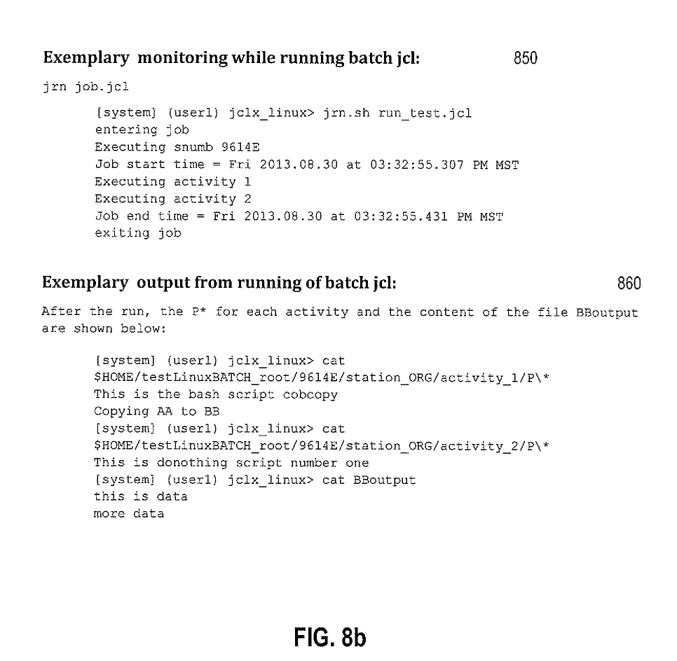

FIG. 8a and FIG. 8b illustrate running of a very simple exemplary batch program on a Linux system with the batch processing being illustrative of one or more aspects of the present invention. FIG. 8a illustrates an exemplary batch jcl file 810 including an “_ident” card 811 providing text description of the job, a “_run” card 812 invoking a program, a “_data” card 813 providing description of where an input file is located, an “_input” card 814 providing for “inline” data input 815 to a program invoked by the batch jcl, a “_prmfl” card 816 providing description of a file system path for a specific file code, an “_if” statement 817 for checking for errors, a second “_run” card 818 specifying a program to be run in a subsequent “activity”, a “_goto” card 819 to illustrate jcl flow control, a third “_run” card 820 which is skipped by the “_goto” statement 819, a label statement 821 (“L100:”) as a target of the “_goto” card 819, and an “_endjob” card 822 to terminate processing.

The illustrated jcl 810 utilizies three different script “programs” 830.

FIG. 8b provides illustration of exemplary output 850 while monitoring running of the exemplary batch jcl 810, and further exemplary output illustrating output saved 860 in a standardized directory structure which provides record of the processing performed by invocation of the batch jcl 81.0

Other aspects of the present invention not explicitly described herein can be derived after presentation of the concepts of the present invention as here presented without departing from practice of this invention. Those derivations may be made by someone knowledgeable in the art of communications, computer programming, caching of data and other similar skills. Having described the preferred embodiments of the invention, it will now become apparent to one skilled in the arts that other embodiments or implementations incorporating the teachings of the present invention may be used. Accordingly, these embodiments should not be limited to the disclosed embodiments or implementations but rather should be limited only by the spirit and scope of the following claims.

What is claimed is:

1) A method for processing batch jobs on a computer system running the Linux operating system, the batch job described in a batch job control file stored in the file system of the computer system, the batch job comprising a plurality of activities, each activity comprising running of at least one program, and launched s by a user of the computer system with a launch command specifying location of the batch job control file, the steps of the method comprising:
A) reading the batch job control file and dividing the batch job into a number of a activities based upon contents of the batch job control file;
B) creating a batch job control directory structure in computer system space accessible to the user;
C) creating, within the batch job control directory structure, a plurality of activity directories for processing of each activity of the batch job;
D) spawning and running programs in a sequence of activities specified in the batch job control file with each program started at a launch location within the batch job control directory structure and with at least one of the programs utilizing the linking files to access a file written in a previous activity;
E) providing for passing files written by one activity of the batch job to a later activity of the batch job utilizing linking files, the linking files stored within the batch job control directory structure; and,
F) capturing and storing within the batch job control directory structure output data and statistics produced by the running of the spawned programs specified in the batch job control file.

2) steps of the method of claim 1 further comprising the step of providing for monitoring during the processing of the batch jobs such that the user can determine which activity of the sequence of activities is currently being processed.
